(19) United States
(12) Patent Application Publication
(10) Pub. No.: US 2010/0053038 A1
(43) Pub. Date: Mar. 4, 2010

(54) COLOR DISPLAY AND METHOD FOR PRODUCING THE SAME

(75) Inventor: Yoshiaki SAKAMOTO, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/506,273

(22) Filed: Jul. 21, 2009

(30) Foreign Application Priority Data
Aug. 29, 2008 (JP) 2008-221880

(51) Int. Cl. G09G 3/30; H01J 9/00

(52) U.S. Cl. 345/76; 445/24

(57) ABSTRACT

A color display including a plurality of pixels on a substrate, each pixels being area-divided into plural sub-pixels including at least two sub-pixels that each emit colored light of different wavelengths and a white sub-pixel, wherein the at least two sub-pixels and the white sub-pixel each have at least an optical path length-adjusting layer and an organic electroluminescence layer interposed between a layer that partially transmits light and partially reflects light and a light reflection layer to form a resonator structure.

### CROSS-REFERENCE TO RELATED APPLICATION

This application claims priority under 35 USC 119 from Japanese Patent Application No. 2008-221880, filed on Aug. 29, 2008, the disclosure of which is incorporated by reference herein.

### BACKGROUND OF THE INVENTION

1. Field of the Invention

The present invention relates to a color display using a light-emitting element and a method for producing the same. In particular, the invention relates to a color display and a method for producing the same.

2. Description of the Related Art

Recently, flat panel displays with a thin shape and light weight have been used in broad fields in place of Braun tubes (CRTs), and applications thereof have been expanded. This has resulted from the accelerated spread of personal information terminals such as personal computers and cellular telephones compatible with network access, due to the development of information devices and infrastructure for service networks having the Internet as a core. In addition, the market for flat panel displays has expanded to home use television sets, which was conventionally the exclusive market of CRTs.

Among these, a device recently receiving a lot of attention in particular is an organic electroluminescence element (hereinafter, referred to as an “organic EL element”, or an “organic light emitting diode” (OLED) in some cases). An organic EL element is a device that emits light corresponding to electric signals and is constituted using an organic compound as a light-emitting material. The organic EL element inherently has excellent display characteristics such as a wide viewing angle, high contrast and high-speed response. Further, there is a possibility that the organic EL element can realize displays of from a small size to a large size with a thin shape and light weight and high image quality. Therefore, the organic EL element has attracted attention as a device capable of replacing CRTs and LCDs.

Various full color displays using an organic EL element have been proposed.

For instance, methods for obtaining three primary colors of a red (R) color, a green (G) color, and a blue (B) color for full color representation include a triple pattern process, a method of combining a color filter with a white organic EL element, a color changing method and the like.

In the triple pattern process, there is a possibility of achieving high efficiency by preparing three appropriate coloring materials as light-emitting materials and reducing loss of a circular polarizing plate. However, since a technique for the triple pattern process is difficult to carry out, it is hard to achieve a high definition display, and it is difficult to increase a display size.

The method of combining a color filter with a white organic EL element has problems in that light-emission efficiency of the white light-emitting material itself is low, and that brightness decreases to about ⅓ due to the color filter.

In the color changing method for obtaining a desired color by changing the color of a light emitted from an organic EL element using a color changing layer, various improvements have been made, but there are still problems in that color changing efficiency to a red color is low, and the like.

In contrast, it has been examined to achieve a high color reproduction by employing a translucent cathode for an upper electrode, and taking out only light of a specific wavelength to the outside of the organic EL element by a multiple interference effect between the upper electrode and a light reflection layer. For example, the following organic EL element is known. The organic EL element is structured so that a first electrode formed of a light reflection material, an organic layer having an organic light-emitting layer, a translucent light reflection layer and a second electrode formed of a transparent material are successively disposed, and the organic layer serves as a resonance part, wherein the following equation is satisfied when the peak wavelength of the spectrum of a desired light to be taken out is represented by λ.

(2L)/λ+φ/(2π)=m

In the equation, L represents an optical path length, λ represents a wavelength of a desired light to be taken out, m represents an integer, and φ represents a phase shift, and the structure is designed so that the optical path length L becomes a minimum positive value.

For example, Japanese National Phase Publication (translation of PCT application) No. 2007-503093 discloses an organic EL display having a microcavity (minute resonator). Specifically, one pixel is divided into sub-pixels of red (R), green (G), and blue (B), wherein each sub-pixel constitutes a resonator, and an organic EL layer is provided in common to all the sub-pixels. It is described that thereby, a simple full color display which does not require individual three color formation or a color filter is obtained. A resonator structure has not been provided in a white sub-pixel part, because, considering the principle of a resonator in which only a specific wavelength is resonated, the structure is not suitable for the purpose of emitting a white light having an emission spectrum over the entire visible range.

Moreover, Japanese Patent Application Laid-Open (JP-A) No. 2007-26867 describes a problem in which, in a display having a resonator structure, a hue varies depending on the direction in which the display surface is observed. As a means to solve the problem, JP-A No. 2007-26867 discloses that a spectrum distribution of light to be obtained is broadened by providing, outside the resonator structure, a color filter whose maximum absorption wavelength is different from the maximum wavelength of light emitted from the resonator. Specifically, it is described that viewing angle dependency is reduced by combining a color filter having an absorption maximum at a wavelength longer than the wavelength of the maximum intensity observed in the normal direction of light emitted from the resonator.

However, a white sub-pixel is important for rich color reproduction and gradation reproduction in a full color display, and it has been desired to solve the problems that occur in the case of providing a white sub-pixel.

### SUMMARY OF THE INVENTION

The present invention has been made in view of the above circumstances and provides a color display and a method for producing the same with the following aspects.

A first aspect of the present invention is to provide a color display comprising a plurality of pixels on a substrate, each pixels being area-divided into plural sub-pixels including at least two sub-pixels that each emit colored light of different wavelengths and a white sub-pixel, wherein the at least two sub-pixels and the white sub-pixel each have at least an optical path length-adjusting layer and an organic electroluminescence layer interposed between a layer that partially transmits light and partially reflects light and a light reflection layer to form a resonator structure.

A second aspect of the present invention is to provide a method for producing a color display in which a plurality of pixels is formed on a substrate, each pixel being area-divided into plural sub-pixels including at least two sub-pixels that each emit colored light of different wavelengths and a white sub-pixel, wherein the white sub-pixel is area-divided into at least two sub-sub-pixels that each emit colored light of different wavelengths, and the at least two sub-pixels and the at least two sub-sub-pixels each form a resonator structure, the resonator structure having at least an optical path length-adjusting layer and an organic electroluminescence layer interposed between a layer that partially transmits light and partially reflects light and a light reflection layer, in which the organic electroluminescence layer is a white light-emitting layer, the method comprising:

successively forming the organic electroluminescence layers of the at least two sub-pixels and the at least two sub-sub-pixels with substantially the same composition;

successively forming the optical path length-adjusting layers of the at least two sub-pixels and the at least two sub-sub-pixels with substantially the same material; and

adjusting a wavelength of light to be emitted by a thickness of the optical path length-adjusting layer.

### BRIEF DESCRIPTION OF THE DRAWINGS

FIG. 1 is a conceptual diagram illustrating an arrangement of pixels in a matrix type display.

FIG. 2 is a conceptual diagram illustrating a sub-pixel arrangement of one pixel.

FIG. 3 is a conceptual diagram illustrating a sub-pixel arrangement of one pixel according to another embodiment.

FIG. 4 is a conceptual diagram illustrating a sub-pixel arrangement of one pixel according to yet another embodiment.

FIG. 5 is a conceptual diagram illustrating a sub-pixel arrangement of one pixel according to yet another embodiment.

FIG. 6 is a conceptual cross-sectional view of one pixel according to the invention.

FIG. 7 is a conceptual cross-sectional view of one pixel according to another embodiment of the invention.

FIG. 8 is a conceptual cross-sectional view of one pixel according to yet another embodiment of the invention.

FIG. 9 is a conceptual cross-sectional view illustrating a method for producing one pixel of the invention in accordance with a process order.

FIG. 10 is a conceptual cross-sectional view illustrating a method for producing one pixel of another embodiment of the invention in accordance with a process order.

FIG. 11 is a conceptual cross-sectional view illustrating a method for producing one pixel of yet another embodiment of the invention in accordance with a process order.

### DETAILED DESCRIPTION OF THE INVENTION

An object of the invention is to provide a color display using a light-emitting element, and a method for producing the same. In particular, the invention aims at providing a color display that allows a high definition color display and is easily produced, and a method for producing the same.

The problems of the invention described above have been solved by a color display comprising a plurality of pixels on a substrate, each pixels being area-divided into plural sub-pixels including at least two sub-pixels that each emit colored light of different wavelengths and a white sub-pixel, wherein the at least two sub-pixels and the white sub-pixel each have at least an optical path length-adjusting layer and an organic electroluminescence layer interposed between a layer that partially transmits light and partially reflects light and a light reflection layer to form a resonator structure.

Preferably, the white sub-pixel is area-divided into at least two sub-sub-pixels that each emit colored light of different wavelengths, and the at least two sub-sub-pixels each form a resonator structure.

Preferably, the at least two sub-pixels include at least three sub-pixels including a red sub-pixel, a green sub-pixel and a blue sub-pixel, and the white sub-pixel includes three sub-sub-pixels of a red sub-sub-pixel, a green sub-sub-pixel and a blue sub-sub-pixel.

Preferably, the resonator structures of the red sub-pixel, the green sub-pixel and the blue sub-pixel, and the resonator structures of the red sub-sub-pixel, the green sub-sub-pixel and the blue sub-sub-pixel are respectively substantially the same for each same color.

Preferably, the organic electroluminescence layers of the at least two sub-pixels and the white sub-pixel are layers that emit a white light, and comprise substantially the same composition as each other.

Preferably, the optical path length-adjusting layer is formed of an inorganic electric insulating material.

Preferably, the optical path length-adjusting layers of the red sub-pixel, the green sub-pixel, the blue sub-pixel, the red sub-sub-pixel, the green sub-sub-pixel, and the blue sub-sub-pixel comprise substantially the same material as each other and are different in thickness.

Preferably, the organic electroluminescence layers of the red sub-pixel, the green sub-pixel, the blue sub-pixel, the red sub-sub-pixel, the green sub-sub-pixel, and the blue sub-sub-pixel respectively comprise layers that emit a white light and have substantially the same composition as each other, and the optical path length-adjusting layers of the red sub-pixel, the green sub-pixel, the blue sub-pixel, the red sub-sub-pixel, the green sub-sub-pixel, and the blue sub-sub-pixel comprise substantially the same material as each other and are different in thickness.

The method for producing a color display of the present invention is a method for producing a color display in which a plurality of pixels is formed on a substrate, each pixel being area-divided into plural sub-pixels including at least two sub-pixels that each emit colored light of different wavelengths and a white sub-pixel, wherein the white sub-pixel is area-divided into at least two sub-sub-pixels that each emit colored light of different wavelengths, and the at least two sub-pixels and the at least two sub-sub-pixels each form a resonator structure.

The resonator structure has at least an optical path length-adjusting layer and an organic electroluminescence layer interposed between a layer that partially transmits light and partially reflects light and a light reflection layer, wherein the organic electroluminescence layer is a white light-emitting layer.

In the method for producing a color display of the present invention, the organic electroluminescence layers of the at least two sub-pixels and the at least two sub-sub-pixels are formed successively with substantially the same composition, the optical path length-adjusting layers of the at least two sub-pixels and the at least two sub-sub-pixels are formed successively with substantially the same material, and a wavelength of light to be emitted is adjusted by a thickness of the optical path length-adjusting layer.

In the method for producing the color display, preferably, the at least two sub-pixels include at least three sub-pixels including a red sub-pixel, a green sub-pixel, and a blue sub-pixel, and the white sub-pixel includes a red sub-sub-pixel, a green sub-sub-pixel, and a blue sub-sub-pixel.

In the method for producing the color display, preferably, the thickness of each of the optical path length-adjusting layers of the red sub-pixel, the green sub-pixel, and the blue sub-pixel and the thickness of each of the optical path length-adjusting layers of the red sub-sub-pixel, the green sub-sub-pixel, and the blue sub-sub-pixel are substantially the same for each same color.

In the method for producing the color display, preferably, the optical path length-adjusting layer is formed of an inorganic electric insulating material.

The present invention provides a display that allows a high definition color display and is easily produced, and a method for producing the same. In particular, since an organic electroluminescence layer can be formed in common for the whole pixel including sub-pixels, it is not necessary to form organic electroluminescence layer portions individually according to emitted colors.

Conventionally, in the case where a resonator structure is provided in R, G, and B sub-pixels, a specific wavelength is resonated when the resonator structure is also provided in a white sub-pixel. As a result, the white sub-pixel is tinted with a specific color, which makes it difficult to perform appropriate color reproduction. A structure in which the resonator structure is omitted from only a white pixel unit complicates the structure of the display and the production process thereof, and furthermore, makes it difficult to achieve high definition.

According to the invention, light emitted from the white sub-pixel has three wavelength characteristics having a resonance point at each color wavelength similar to that in the R, G, and B sub-pixels, and a color tone can be improved.

Hereinafter, the present invention will be described in more detail.

### 1. Display

The display of the present invention has plural pixels on a substrate in which each pixel is area-divided into plural sub-pixels including at least two sub-pixels that each emit colored light of different wavelengths.

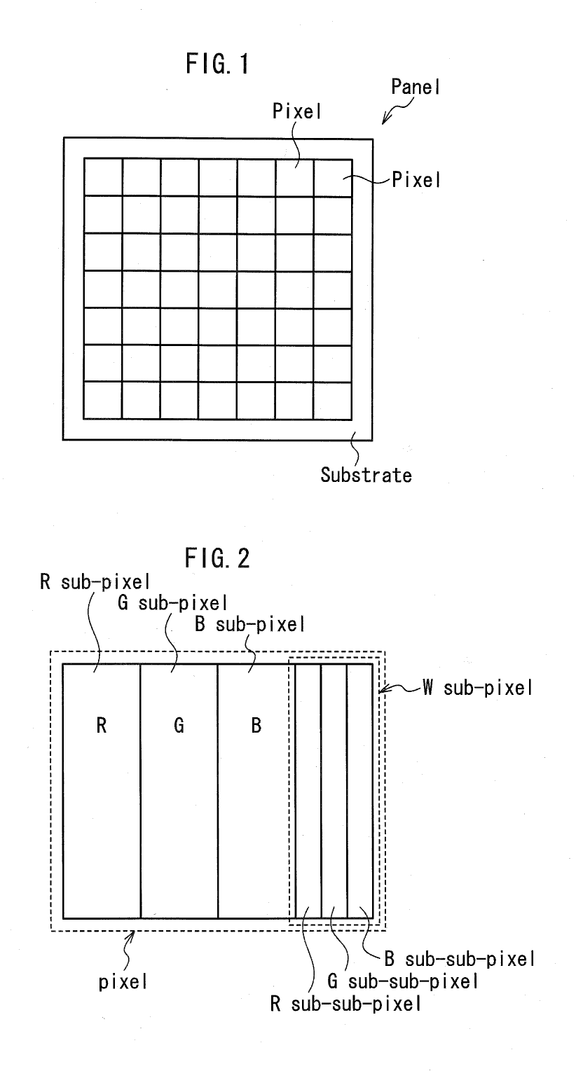

As illustrated in FIG. 1, the display of the invention has a matrix screen panel in which plural pixels are arranged in a matrix on a substrate. Each pixel contains at least two sub-pixels that each emit colored light of different wavelengths and a white sub-pixel, and each sub-pixel forms a resonator structure. By independently controlling the sub-pixels, the brightness of each sub-pixel is controlled independently, and thereby, full color reproduction can be achieved.

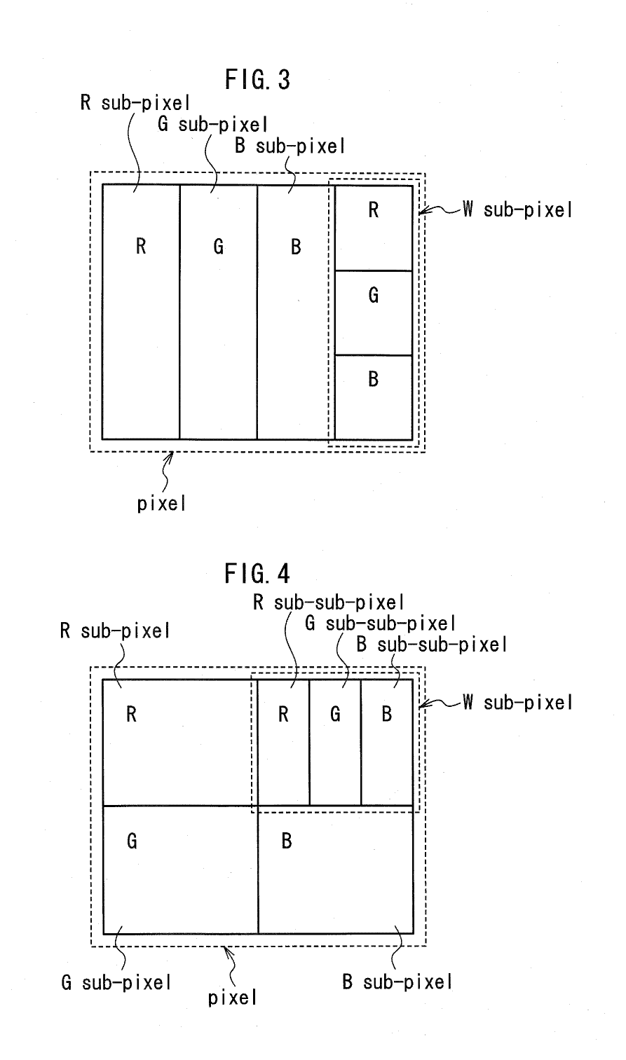

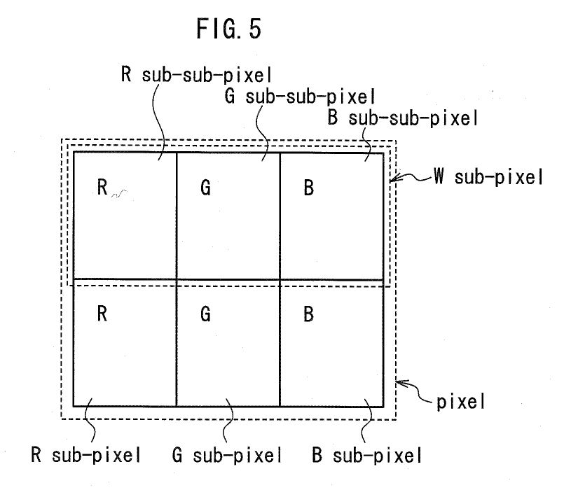

Preferably, the white sub-pixel is further area-divided into at least two sub-sub-pixels, and each sub-sub-pixel forms a resonator structure. A particularly preferable structure has a red sub-pixel (R sub-pixel), a green sub-pixel (G sub-pixel), a blue sub-pixel (B sub-pixel), and a white sub-pixel (W sub-pixel) having a red sub-sub-pixel (R sub-sub-pixel), a green sub-sub-pixel (G sub-sub-pixel), and a blue sub-sub-pixel (B sub-sub-pixel). FIG. 2 is a conceptual diagram illustrating the structure in which the sub-sub-pixels of the white sub-pixel unit are arranged in the column in a similar manner to the arrangement of the sub-pixels. FIGS. 3 to 5 are conceptual diagrams illustrating the arrangement of the sub-sub-pixels of the white sub-pixel unit according to another embodiment.

In the invention, the at least two sub-pixels and the white sub-pixel each have at least an optical path length-adjusting layer and an organic electroluminescence layer interposed between a layer that partially transmits light and partially reflects light and a light reflection layer to form a resonator structure.

Preferably, the white sub-pixel (W sub-pixel) is further area-divided into at least two sub-sub-pixels that each emit colored light of different wavelengths, and the at least two sub-sub-pixels each form a resonator structure.

Preferably, the at least two sub-pixels have a red sub-pixel (R sub-pixel), a green sub-pixel (G sub-pixel), and a blue sub-pixel (B sub-pixel), and the white sub-pixel has a red sub-sub-pixel (R sub-sub-pixel), a green sub-sub-pixel (G sub-sub-pixel), and a blue sub-sub-pixel (B sub-sub-pixel).

Preferably, the resonator structures of the R sub-pixel, the G sub-pixel and the B sub-pixel and the resonator structures of the R sub-sub-pixel, the G sub-sub-pixel, and the B sub-sub-pixel are substantially the same for each same color.

Preferably, the organic electroluminescence layers are organic electroluminescence layers that each emit a white light, and the organic electroluminescence layers of the at least two sub-pixels and the white sub-pixel have substantially the same composition as each other.

Preferably, the optical path length-adjusting layer is formed of an inorganic electric insulating material.

Preferably, the optical path length-adjusting layers of the R sub-pixel, the G sub-pixel, the B sub-pixel, the R sub-sub-pixel, the G sub-sub-pixel, and the B sub-sub-pixels are formed of substantially the same material and are different in the thickness.

In the invention, either a top emission organic EL element or a bottom emission organic EL element may be employed.

Next, the structure of the display of the invention will be specifically described with reference to the drawings.

In the invention, an arrangement of the sub-sub-pixel is not particularly limited, but, hereinafter, the display of the invention and a method for producing the same will be described with respect to an embodiment of the structure illustrated in FIG. 2.

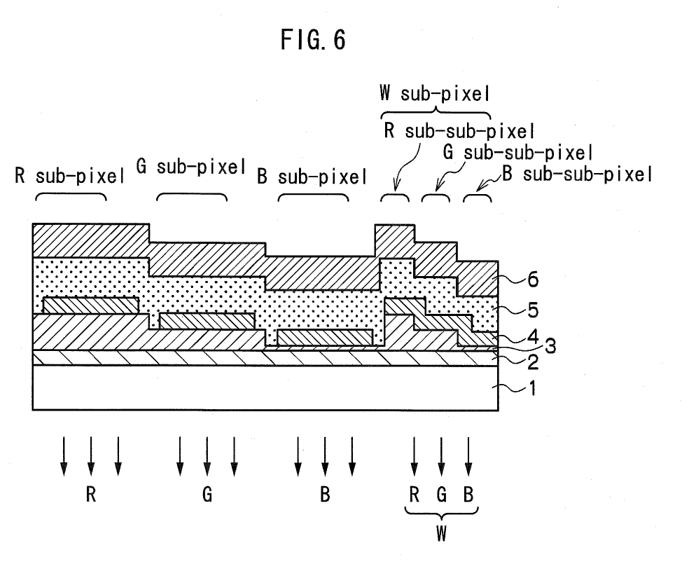

FIG. 6 is a schematic configuration diagram illustrating a cross sectional view of the structure of one pixel of the invention.

On a transparent substrate 1, the sub-pixels and sub-sub-pixels each have a layer that partially transmits light and partially reflects light 2 in common. The layer that partially transmits light and partially reflects light 2 may be any of a metal thin layer (Al, Ag, or the like) or a Distribution Bragg Reflection film (DBR) in which transparent thin layers having different refractive indices are laminated.

An electric insulating layer 3 formed of a light transmitting electric insulating material is provided thereon in the sub-pixel unit. The electric insulating layer 3 is an optical path length-adjusting layer and is formed while varying a film thickness according to the positions of the R, G, and B sub-pixels so that each of the R, G, and B sub-pixels efficiently resonates. Simultaneously, an area at the position of the W sub-pixel is divided into R, G, and B areas (corresponding to the R, G, and B sub-sub-pixels), and then the electric insulating layer 3 is formed while mutually varying the film thickness similarly as in the R, G, and B sub-pixels. For example, a film thickness of an optical distance L (L=λ/2×m, λ: output wavelength, m: natural number) that generates optical resonance in an R light (λ=625 nm to 740 nm), a G light (λ=500 nm to 565 nm), or a B light (λ=450 nm to 485 nm) is achieved between the layer that partially transmits light and partially reflects light 2 and a light reflection electrode 6 mentioned later. A material for the electric insulating layer may be any of an inorganic material (SiO₂, SiON, SiN, ITO, IZO, or the like) or an organic material (polycarbonate, polyacrylate, silicone resin, or the like).

On the electric insulating layer 3, a transparent electrode 4 (first electrode) is patterned for each sub-pixel. On the W sub-pixel unit, a transparent electrode is formed in common to all the sub-sub-pixels.

An organic electroluminescence layer 5 and the light reflection electrode 6 (second electrode) are formed thereon in common to all the sub-pixels. Light emitted in the organic electroluminescence layer 5 repeats reflection between the layer that partially transmits light and partially reflects light 2 and the light reflection electrode 6 and resonates, and then R, G, and B lights transmit through the substrate 1 to be emitted to the outside. In the W sub-pixel unit, the resonated R, G, and B lights are mixed to be observed as a white light.

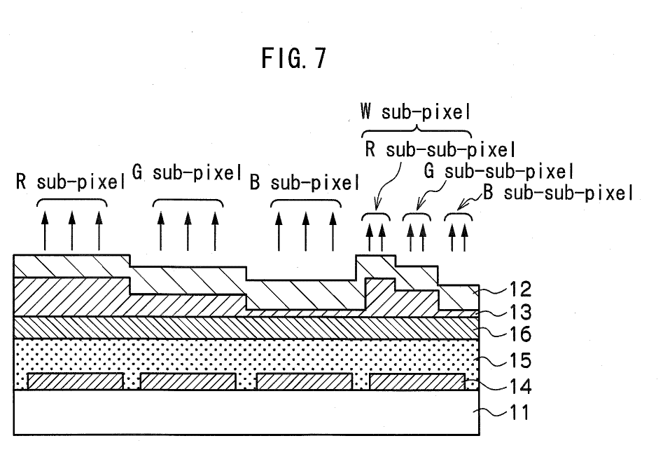

FIG. 7 is a schematic configuration diagram illustrating a cross sectional view of the structure of one pixel according to another embodiment of the invention.

On a substrate 11, a light reflection electrode 14 (first electrode) that are patterned, an organic electroluminescence layer 15, and a transparent electrode 16 (second electrode) are formed in common to all the sub-pixels. An electric insulating layer 13 is formed thereon while varying the film thickness, at the positions of the R, G, B sub-pixels and the positions of the R, G, and B sub-sub-pixels of the W sub-pixel. The electric insulating layer 13 is an optical path length-adjusting layer, and is formed while varying the film thickness so that each of the R, G, and B sub-pixels efficiently resonates according to the positions of the R, G, and B sub-pixels. A layer that partially transmits light and partially reflects light 12 is formed thereon.

Light emitted in the organic electroluminescence layer 15 by applying an electric current repeats reflection between the light reflection electrode 14 and the layer that partially transmits light and partially reflects light 12 and resonates, and, as a result, R, G, and B lights transmit through the layer that partially transmits light and partially reflects light 12 to be emitted to the outside. In the W sub-pixel unit, the resonated R, G, and B lights are mixed to be observed as a white light.

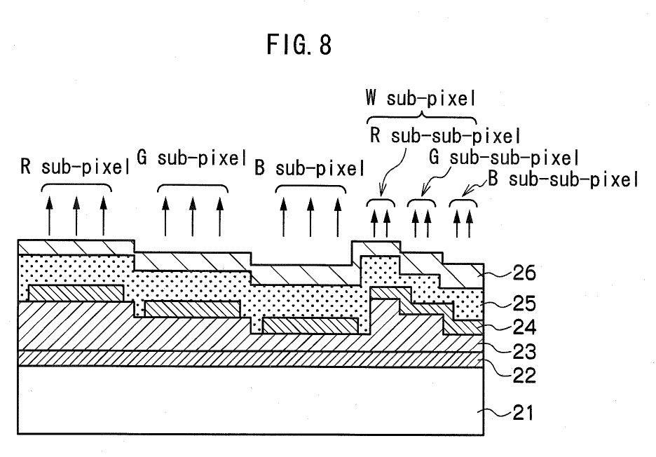

FIG. 8 is a schematic configuration diagram illustrating a cross sectional view of the structure of one pixel according to yet another embodiment of the invention.

On a substrate 21, a light reflection layer 22 is formed in common to all the sub-pixels and an electric insulating layer 23 is formed thereon while varying the film thickness at the positions of the R, G, and B sub-pixels and the positions of the R, G, and B sub-sub-pixels of the W sub-pixel. The electric insulating layer 23 is an optical path length-adjusting layer, and is formed while varying the film thickness according to the positions of the R, G, and B sub-pixels so that each of the R, G, and B sub-pixels efficiently resonates.

A patterned transparent electrode 24 (first electrode) is formed thereon.

An organic electroluminescence layer 25 and an electrode that partially transmits light and partially reflects light 26 (second electrode) are formed thereon in common to all the sub-pixels and sub-sub-pixels.

Light emitted in the organic electroluminescence layer 25 by applying an electric current repeats reflection between the light reflection layer 22 and the electrode that partially transmits light and partially reflects light 26 and resonates, and, as a result, R, G, and B lights transmit through the electrode that partially transmits light and partially reflects light 26 to be emitted to the outside. In the W sub-pixel unit, the resonated R, G, and B lights are mixed to be observed as a white light.

Thus, according to the invention, each light emitted from each sub-pixel is light having high brightness and high saturation having a narrow spectrum distribution, and emission of lights having wavelength components other than a resonant wavelength from each sub-pixel is suppressed. Therefore, light of extremely high brightness and extremely high saturation is obtained.

According to the invention, the light emitted from the W sub-pixel unit has three wavelength characteristics including an optical resonance similar to that of R, G, and B sub-pixel units, and a color tone is improved. Conventionally, when a resonator is provided in the W sub-pixel unit, there has been a problem in that the color tone deteriorates due to undesired resonance, or the color tone changes depending on a viewing angle. In contrast, the light of the W sub-pixel unit of the invention is composed by R, G, and B lights obtained from each resonator of the sub-sub-pixels, and thus an excellent color tone of high brightness can be stably obtained.

Moreover, the invention has advantages in that the organic electroluminescence layers of the R, G, B sub-pixels and the R, G, and B sub-sub-pixels can be consistently formed in common, and the optical path length-adjusting layers also can be consistently formed at the beginning. Therefore, the production process is simple, the productivity is high, and high definition is easily achieved.

### 2. Resonance Structure

The resonance structure in the invention is structured so that an organic EL layer and an optical path length-adjusting layer are interposed between a pair of a light reflection layer and a layer that partially transmits light and partially reflects light, and the optical thickness of the organic EL layer and the optical thickness of the layer that partially transmits light and partially reflects light are adjusted so as to obtain an optical path length in which a radiation light from the organic EL layer resonates. Light with high color purity that has been intensified by resonance transmits through the layer that partially transmits light and partially reflects light to be taken out outside.

At least one of the upper electrode or the lower electrode of the organic EL part is a light reflection layer or a layer that partially transmits light and partially reflects light.

Preferably, the layer that partially transmits light and partially reflects light has a light transmittance of from 5% to 50%, and a light reflectance of from 50% to 90%.

Preferably, a material constituting the layer that partially transmits light and partially reflects light is a metal material. The metal material is preferably selected from the group consisting of platinum, gold, silver, chromium, tungsten, aluminum, magnesium, calcium, and sodium, or an alloy thereof.

Preferably, a thickness of the layer that partially transmits light and partially reflects light is from 5 nm to 50 nm.

As a method of designing the resonance structure, known methods can be applied. For example, JP-A Nos. 06-283271, 07-282981, and 09-180883, J. Appl. Phys., vol. 86, No. 5, 1 Sep. 1999, pages 2407-2411, by Tokito et al.; Appl. Phys. Lett., 63 (5), 2 Aug. 1993, pages 594-595, by Nakayama, et al.; Appl. Phys. Lett., 63 (15), 11 Oct. 1993, pages 2032-2034, by Takada et al., etc.; and the like describe methods for adjusting the resonance structure. The invention may use any of the methods.

### 3. Optical Path Length-Adjusting Layer

A material of the optical path length-adjusting layer in the invention is not particularly limited as long as it is a transparent electric insulating material. The inorganic electric insulating material (SiO₂, SiON, SiN, ITO, IZO or the like) or an organic material (polycarbonate, polyacrylate, silicone resin or the like) may be used.

The inorganic electric insulating material for the optical path length-adjusting layer in the invention includes various known metal oxides, metal nitrides, metal fluorides and the like.

Specific examples of metal oxides include MgO, SiO₂, Al₂O₃, Y₂O₃, TiO₂ and the like. Specific examples of metal nitrides include SiNₓ, SiO_{y}Nₓ, AlN and the like. Specific examples of metal fluorides include MgF₂, LiF, AlF₃, CaF₂, BaF₂ and the like. Moreover, mixtures thereof may be acceptable.

A material of the optical path length-adjusting layer in the invention includes an organic material. A film forming polymer is preferably used. Examples of the film forming polymer include polycarbonate, polyacrylate, a silicone resin, polyvinyl butyral and the like.

The thickness of the optical path length-adjusting layer is adjusted so that each sub-pixel has an optical distance in which light of a specific wavelength can efficiently resonate. Therefore, the resonating optical distance is determined by the refractive index, composition, and thickness of a material interposed between the light reflection layer and the layer that partially transmits light and partially reflects light, and is not determined only by the optical path length-adjusting layer. Considering the structure of a generally used organic EL layer, the thickness of the optical path length-adjusting layer of each of the R sub-pixel unit and the R sub-sub-pixel unit is, in terms of physical thickness, preferably from 150 nm to 350 nm, and more preferably from 200 nm to 250 nm. The thickness of the optical path length-adjusting layer of each of the G sub-pixel unit and the G sub-sub-pixel unit is, in terms of physical thickness, preferably from 100 nm to 250 nm, and more preferably from 150 nm to 200 nm. The thickness of the optical path length-adjusting layer of each of the B sub-pixel unit and the B sub-sub-pixel unit is, in terms of physical thickness, preferably from 50 nm to 200 nm, and more preferably from 100 nm to 150 nm.

A method for forming the optical path length-adjusting layer is not particularly limited. For example, a vacuum deposition method, a sputtering method, a reactive-sputtering method, an MBE (molecular beam epitaxy) method, a cluster ion beam method, an ion plating method, a plasma polymerization method (high-frequency excitation ion plating method), a plasma CVD (chemical vapor deposition) method, a laser-CVD method, a thermal CVD method, a gas source CVD method, a coating method, a printing method, or a transfer method is applicable.

### 4. Organic Electroluminescence Element

An organic electroluminescence element in the present invention has an organic electroluminescence layer between a pair of electrodes. An organic electroluminescence layer includes, in addition to a light-emitting layer, generally known organic compound layer such as a hole-transport layer, an electron-transport layer, a blocking layer, an electron-injection layer, a hole-injection layer or the like.

In the following, the organic electroluminescence element of the present invention will be described in detail.

1) Layer Configuration

<Electrode>

At least one of a pair of electrodes of the organic electroluminescence element of the present invention is a transparent electrode, and the other one is a rear surface electrode. The rear surface electrode may be transparent or non-transparent.

<Configuration of Organic Compound Layer>

A layer configuration of the organic compound layer can be appropriately selected, without particular limitation, depending on the application of the organic electroluminescence element and the purpose thereof. However, the organic compound layers are preferably formed on the transparent electrode or the rear surface electrode. In these cases, the organic compound layers are formed on front surfaces or one surface on the transparent electrode or the rear surface electrode.

A shape, size and thickness of the organic compound layers can be appropriately selected, without particular limitation, depending on the purpose of the organic electroluminescence element.

Examples of specific layer configurations include those cited below, but the present invention is not limited to these examples.

Anode/hole transport layer/light-emitting layer/electron transport layer/cathode,

Anode/hole transport layer/light-emitting layer/blocking layer/electron transport layer/cathode,

Anode/hole transport layer/light-emitting layer/blocking layer/electron transport layer/electron injection layer/cathode,

Anode/hole injection layer/hole transport layer/light-emitting layer/blocking layer/electron transport layer/cathode, and

Anode/hole injection layer/hole transport layer/light-emitting layer/blocking layer/electron transport layer/electron injection layer/cathode.

In the following, the respective layers will be described in detail.

2) Hole Transport Layer

The hole transport layer used in the present invention includes a hole transporting material. For the hole transporting material, any material can be used without particular limitation as long as it has either one of a function of transporting holes or a function of blocking electrons injected from the cathode. As the hole transporting material that can be used in the present invention, either one of a low molecular weight hole transporting material or a polymer hole transporting material can be used.

Specific examples of the hole transporting material that can be used in the present invention include a carbazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidene-based compound, a porphyrin-based compound, a polysilane-based compound, a poly(N-vinylcarbazole) derivative, an aniline-based copolymer, electric conductive polymers or oligomers such as a thiophene oligomer and polythiophene, and polymers such as a polythiophene derivative, a polyphenylene derivative, a polyphenylenevinylene derivative, a polyfluorene derivative or the like.

These compounds may be used alone or in a combination of two or more of them.

A thickness of the hole transport layer is preferably from 10 nm to 400 nm and more preferably from 50 nm to 200 nm.

3) Hole Injection Layer

In the present invention, a hole injection layer may be disposed between the hole transport layer and the anode.

The hole injection layer is a layer that makes it easy for holes to be injected from the anode to the hole transport layer, and specifically, a material having a small ionization potential among the hole transporting materials cited above is preferably used. For instance, a phthalocyanine compound, a porphyrin compound and a star-burst type triarylamine compound can be preferably used.

A film thickness of the hole injection layer is preferably from 1 nm to 300 nm.

4) Light-Emitting Layer

The light-emitting layer used in the present invention comprises at least one light-emitting material, and may comprise as necessary other compounds such as a hole transporting material, an electron transporting material, and a host material.

Any of light-emitting materials can be used without particular limitation. Either of fluorescent light-emitting materials or phosphorescent light-emitting materials can be used, but phosphorescent light-emitting materials are preferred in view of the light-emission efficiency.

As a light-emitting material, a white light-emitting material may be used singly, or two or more light-emitting materials may be used in combination to obtain a white light. When two or more light-emitting materials are used in combination, a combination of colors of light emitted from the light-emitting materials is not particularly limited. Examples of combinations include a combination of a blue light-emitting material and a yellow light-emitting material, a combination of a blue light-emitting material, a green light-emitting material and a red light-emitting material and the like.

Examples of the above-described fluorescent light-emitting materials include a benzoxazole derivative, a benzimidazole derivative, a benzothiazole derivative, a styrylbenzene derivative, a polyphenyl derivative, a diphenylbutadiene derivative, a tetraphenylbutadiene derivative, a naphthalimide derivative, a coumarin derivative, a perylene derivative, a perinone derivative, an oxadiazole derivative, an aldazine derivative, a pyralidine derivative, a cyclopentadiene derivative, a bis-styrylanthracene derivative, a quinacridone derivative, a pyrrolopyridine derivative, a thiadiazolopyridine derivative, a styrylamine derivative, aromatic dimethylidene compounds, a variety of metal complexes represented by metal complexes or rare-earth complexes of 8-quinolinol derivative, polymers such as a polythiophene derivative, a polyphenylene derivative, a polyphenylenevinylene derivative, and a polyfluorene derivative, and the like. These compounds may be used alone or in a combination of two or more of them.

The phosphorescent light-emitting material is not particularly limited, but an ortho-metal complex or a porphyrin metal complex is preferred.

The ortho-metal complex referred to herein is a generic designation of a group of compounds described in, for instance, Akio Yamamoto, Yuki Kinzoku Kagaku, Kiso to Oyo (“Organometallic Chemistry, Fundamentals and Applications”) (Shokabo, 1982), pages 150 to 232, and H. Yersin, Photochemistry and Photophysics of Coordination Compounds (New York: Springer-Verlag, 1987), pages 71-77 and pages 135-146. The ortho-metal complex can be advantageously used as a light-emitting material because high brightness and excellent light-emission efficiency can be obtained.

As a ligand that forms the ortho-metal complex, various ligands can be cited and are described in the above-mentioned literature as well. Examples of preferable ligands include a 2-phenylpyridine derivative, a 7,8-benzoquinoline derivative, a 2-(2-thienyl)pyridine derivative, a 2-(1-naphtyl)pyridine derivative and a 2-phenylquinoline derivative. The derivatives may be substituted by a substituent as needs arise. Furthermore, the ortho-metal complex may have other ligands than the ligands mentioned above.

An ortho-metal complex used in the present invention can be synthesized according to various known processes such as those described in Inorg. Chem., 1991, vol. 30, pp. 1685; Inorg. Chem., 1988, vol. 27, page 3464; Inorg. Chem., 1994, vol. 33, page 545; Inorg. Chim. Acta, 1991, vol. 181, page 245; J. Organomet. Chem., 1987, vol. 335, page 293; and J. Am. Chem. Soc., 1985, vol. 107, page 1431.

Among the ortho-metal complexes, compounds which emit light from a triplet exciton can be preferably employed in the present invention from the viewpoint of improving light-emission efficiency.

Furthermore, among the porphyrin metal complexes, a porphyrin platinum complex is preferable.

The phosphorescent light-emitting materials may be used alone or in a combination of two or more of them. Furthermore, a fluorescent light-emitting material and a phosphorescent light-emitting material may be simultaneously used.

A host material is a material that has a function of causing an energy transfer from an excited state thereof to the fluorescent light-emitting material or the phosphorescent light-emitting material to cause light emission from the fluorescent light-emitting material or the phosphorescent light-emitting material.

As the host material, as long as the compound can transfer exciton energy to a light-emitting material, any compound can be appropriately selected and used depending on the purpose without particular limitation. Specific examples thereof include: a carbazole derivative; a triazole derivative; an oxazole derivative; an oxadiazole derivative; an imidazole derivative; a polyarylalkane derivative; a pyrazoline derivative; a pyrazolone derivative; a phenylenediamine derivative; an arylamine derivative; an amino-substituted chalcone derivative; a styrylanthracene derivative; a fluorenone derivative; a hydrazone derivative; a stilbene derivative; a silazane derivative; an aromatic tertiary amine compound; a styrylamine compound; an aromatic dimethylidene-based compound; a porphyrin-based compound; an anthraquinodimethane derivative; an anthrone derivative; a diphenylquinone derivative; a thiopyran dioxide derivative; a carbodiimide derivative; a fluorenylidenemethane derivative; a distyrylpyrazine derivative; aromatic ring tetracarboxylic anhydrides of naphthalene, perylene, or the like; a phthalocyanine derivative; various metal complexes typified by metal complexes of a 8-quinolinol derivative, metal phthalocyanine, and metal complexes with benzoxazole or benzothiazole as a ligand; polysilane compounds; a poly(N-vinylcarbazole) derivative; an aniline-based copolymer; electric conductive polymers or oligomers such as a thiophene oligomer and polythiophene; polymers such as a polythiophene derivative, a polyphenylene derivative, a polyphenylenevinylene derivative and a polyfluorene derivative; and like. These compounds can be used alone or in a combination of two or more of them.

A content of the host material in the light-emitting layer is preferably in a range of from 0% by weight to 99.9% by weight and more preferably in a range of 0% by weight to 99.0% by weight.

5) Blocking Layer

In the present invention, a blocking layer may be disposed between the light-emitting layer and the electron transport layer. The blocking layer is a layer that inhibits excitons generated in the light-emitting layer from diffusing and holes from penetrating to a cathode side.

A material that is used in the blocking layer may be a general electron transporting material, as long as it can receive electrons from the electron transport layer and deliver them to the light-emitting layer, without being particularly limited. Examples thereof include a triazole derivative; an oxazole derivative; an oxadiazole derivative; a fluorenone derivative; an anthraquinodimethane derivative; an anthrone derivative; a diphenylquinone derivative; a thiopyran dioxide derivative; a carbodiimide derivative; a fluorenylidenemethane derivative; a distyrylpyrazine derivative; aromatic ring tetracarboxylic anhydrides of naphthalene, perylene, or the like; a phthalocyanine derivative; various metal complexes typified by metal complexes of a 8-quinolinol derivative, metal phthalocyanine, and metal complexes with benzoxazole or benzothiazole as a ligand; electric conductive polymers or oligomers such as an aniline-based copolymer, a thiophene oligomer and polythiophene; and polymes such as a polythiophene derivative, a polyphenylene derivative, a polyphenylenevinylene derivative and a polyfluorene derivative. These can be used alone or in a combination of two or more of them.

6) Electron Transport Layer

In the present invention, an electron transport layer including an electron transporting material can be disposed.

The electron transporting material can be used without particular limitation, as long as it has either one of a function of transporting electrons or a function of blocking holes injected from the an anode. The electron transporting materials that are described above in the explanation of the blocking layer can be preferably used.

A thickness of the electron transport layer is preferably from 10 nm to 200 nm and more preferably from 20 nm to 80 nm.

When the thickness exceeds 200 nm, driving voltage increases in some cases. When it is less than 10 nm, the light-emission efficiency of the light-emitting element may be greatly deteriorated, which is not preferable.

7) Electron Injection Layer

In the present invention, an electron injection layer can be disposed between the electron transport layer and the cathode.

The electron injection layer is a layer by which electrons can be readily injected from the cathode to the electron transport layer. Specifically, lithium salts such as lithium fluoride, lithium chloride and lithium bromide; alkali metal salts such as sodium fluoride, sodium chloride and cesium fluoride; and electrically insulating metal oxides such as lithium oxide, aluminum oxide, indium oxide and magnesium oxide can be preferably used.

A film thickness of the electron injection layer is preferably from 0.1 nm to 5 nm.

8) Substrate

The substrate to be applied in the present invention is preferably impermeable to moisture or very slightly permeable to moisture. Furthermore, the substrate preferably does not scatter or attenuate light emitted from the organic compound layer. Specific examples of materials for the substrate include inorganic materials such as YSZ (zirconia-stabilized yttrium) and glass; and organic materials including polyesters such as polyethylene terephthalate, polybutylene phthalate and polyethylene naphthalate, and synthetic resins such as polystyrene, polycarbonate, polyethersulfone, polyarylate, aryldiglycolcarbonate, polyimide, polycycloolefin, norbornene resin, poly(chlorotrifluoroethylene), and the like.

In the case of employing an organic material, it is preferred to use a material excellent in heat resistance, dimensional stability, solvent resistance, electric insulation performance, workability, low gass-permeability, and low moisture-absorption. These can be used alone or in a combination of two or more of them.

There is no particular limitation as to the shape, the structure, the size and the like of the substrate, but it may be suitably selected according to the application, the purposes and the like of the light-emitting element. In general, a plate-like substrate is preferred as the shape of the substrate. The structure of the substrate may be a monolayer structure or a laminated structure. Furthermore, the substrate may be formed from a single member or from two or more members.

Although the substrate may be transparent and colorless, or transparent and colored, it is preferred that the substrate is transparent and colorless from the viewpoint that the substrate does not scatter or attenuate light emitted from the light-emitting layer.

A moisture permeation preventive layer (gas barrier layer) may be provided on the front surface or the back surface (on the transparent electrode side) of the substrate. For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

The substrate may have a hard-coat layer, an under-coat layer or the like as necessary.

9) Electrodes

Concerning the electrodes in the invention, either one of the first electrode or the second electrode can be an anode or a cathode. It is preferable that the first electrode is the anode and the second electrode is the cathode.

<Anode>

The anode in the present invention may generally have a function as an anode for supplying holes to the organic compound layer, and while there is no particular limitation as to the shape, the structure, the size and the like of the anode, it may be suitably selected from among well-known electrodes according to the application and the purpose of the light-emitting element.

As materials for the anode, for example, metals, alloys, metal oxides, organic electric conductive compounds, and mixtures thereof are preferably used, wherein those having a work function of 4.0 eV or more are preferred. Specific examples of the anode materials include semi-electric conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electric conductive metal oxides; inorganic electric conductive materials such as copper iodide, and copper sulfide; organic electric conductive materials such as polyaniline, polythiophene, and polypyrrole; and laminates of these inorganic or organic electric conductive materials with ITO.

The anode may be formed on the substrate, for example, in accordance with a method which is appropriately selected from among wet methods such as a printing method, a coating method and the like; physical methods such as a vacuum deposition method, a sputtering method, an ion plating method and the like; and chemical methods such as CVD and plasma CVD methods and the like in consideration of the suitability to a material constituting the anode. For instance, when ITO is selected as a material for the anode, the anode may be formed in accordance with a DC or high-frequency sputtering method, a vacuum deposition method, an ion plating method or the like. Further, when an organic electric conductive compound is selected as a material for the anode, the anode may be formed in accordance with a wet film forming method.

A position at which the anode is to be formed in the light-emitting element is not particularly limited, but it may be suitably selected according to the application and the purpose of the light-emitting element. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, and a lift-off method or a printing method may be applied.

A thickness of the anode may be suitably selected depending on the material constituting the anode, and is not definitely decided, but it is usually in a range of from 10 nm to 50 μm, and more preferably from 50 nm to 20 μm.

A value of electric resistance of the anode is preferably 10³ Ω/□ or less, and more preferably 10² Ω/□ or less.

The anode may be colorless and transparent or colored and transparent. For extracting luminescence from the transparent anode side, it is preferred that a light transmittance of the anode is 60% or higher, and more preferably 70% or higher. The light transmittance in the present invention can be measured by means well known in the art using a spectrophotometer.

Concerning the anode, there is a detailed description in “TOUMEI DENNKYOKU-MAKU NO SHINTENKAI (Novel Developments in Transparent Electrode Films)” edited by Yutaka Sawada and published by C.M.C. in 1999, the contents of which are incorporated by reference herein. In the case where a plastic substrate of a low heat resistance is applied, it is preferred that ITO or IZO is used to obtain an anode prepared by forming the film at a low temperature of 150° C. or lower.

<Cathode>

The cathode in the present invention may generally have a function as an electrode for injecting electrons to the organic compound layer, and there is no particular limitation as to the shape, the structure, the size and the like. Accordingly, the cathode may be suitably selected from among well-known electrodes according to the application and purposes of the light-emitting element.

As the materials constituting the cathode, for example, metals, alloys, metal oxides, electric conductive compounds, and mixtures thereof may be used, wherein materials having a work function of 4.5 eV or less are preferred. Specific examples thereof include alkali metals (e.g., Li, Na, K, Cs or the like); alkaline earth metals (e.g., Mg, Ca or the like); gold; silver; lead; aluminum; sodium-potassium alloys; lithium-aluminum alloys; magnesium-silver alloys; rare earth metals such as indium and ytterbium; and the like. They may be used alone, but it is preferred that two or more of them are used in combination from the viewpoint of satisfying both of stability and electron injectability.

Among these, as the materials for constituting the cathode, alkaline metals or alkaline earth metals are preferred in view of electron injectability, and materials containing aluminum as the major component are preferred in view of excellent preservation stability. The term “material containing aluminum as the major component” refers to a material that material exists in the form of aluminum alone; alloys comprising aluminum and 0.01% by mass to 10% by mass of an alkaline metal or an alkaline earth metal; or mixtures thereof (e.g., lithium-aluminum alloys, magnesium-aluminum alloys and the like).

As for materials for the cathode, they are described in detail in JP-A Nos. 2-15595 and 5-121172, the contents of which are incorporated by reference herein.

A method for forming the cathode is not particularly limited, but it may be formed in accordance with a well-known method. For instance, the cathode may be formed on the substrate described above in accordance with a method which is appropriately selected from among wet methods such as a printing method, a coating method and the like; physical methods such as a vacuum deposition method, a sputtering method, an ion plating method and the like; and chemical methods such as CVD and plasma CVD methods and the like, while taking the suitability to a material constituting the cathode into consideration.

For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, and a lift-off method or a printing method may be applied.

In the present invention, a position at which the cathode is to be formed in the organic electroluminescence element is not particularly limited, and it may be suitably selected according to the application and the purpose of the light-emitting element. The cathode is preferably formed on the organic compound layer. In this case, the cathode may be formed on either the whole or a part of the organic compound layer.

Furthermore, a dielectric material layer made of a fluoride or the like of an alkaline metal or an alkaline earth metal may be inserted between the cathode and the organic compound layer with a thickness of from 0.1 nm to 5 nm.

A thickness of the cathode may be suitably selected depending on the materials for constituting the cathode and is not definitely decided, but it is usually in a range of from 10 nm to 5 μm, and preferably from 50 nm to 1 μm.

Moreover, the cathode may be transparent or opaque. The transparent cathode may be formed by preparing a material for the cathode with a small thickness of from 1 nm to 10 nm, and further laminating a transparent electric conductive material such as ITO or IZO thereon.

10) Protective Layer

In the present invention, the whole organic EL element may be protected by a protective layer.

A material contained in the protective layer may be one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

11) Sealing

The whole organic electroluminescence element of the present invention may be sealed with a sealing cap.

Furthermore, a moisture absorbent or an inert liquid may be used to seal a space defined between the sealing cap and the light-emitting element. The moisture absorbent is not particularly limited. Specific examples thereof include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorine-based solvents such as perfluoroalkanes, perfluoroamines, perfluoroethers and the like; chlorine-based solvents; silicone oils; and the like.

12) Method for Producing Element

The respective layers that constitute the element in the present invention can be preferably formed by any method of dry film forming methods such as a vapor deposition method and a sputtering method, and wet film forming methods such as a dipping method, a spin coating method, a dip coating method, a casting method, a die coating method, a roll coating method, a bar coating method and a gravure coating method.

Among these, from the viewpoints of light-emission efficiency and durability, the dry film forming methods are preferable. In the case of the wet film forming methods, a residual coating solvent unfavorably damages the light-emitting layer.

Particularly preferably, a resistance heating vacuum deposition method is used. In the resistance heating vacuum deposition method, since only a substance that can be transpired by heating under a vacuum atmosphere can be efficiently heated, whereby the element is not exposed to a high temperature, the element is advantageously subjected to less damage.

The vacuum deposition method is a method in which, in a vacuumed vessel, a deposition material is heated to vaporize or sublimate to deposit on a surface of an adherend disposed at a slightly distanced position to form a thin film. Depending on the kind of the deposition material and the adherend, resistance heating, an electron beam, high-frequency induction, laser or the like is used to carry out heating. Among these, the one that can form a layer at the lowest temperature is the resistance heating vacuum deposition method. Although it cannot form a layer with a material having a high sublimation temperature, all materials that have a low sublimation temperature can form a layer in a state where the adherent material is hardly thermally affected.

The material for sealing film in the present invention is characterized in that it can form a layer by means of the resistance heating vacuum deposition method. A conventional sealing material such as silicon oxide, being high in sublimation temperature, has been impossible to deposit by means of resistance heating. Furthermore, in a vacuum deposition method such as an ion plating method generally described in known examples, since a vaporizing portion becomes such a high temperature as several thousands of degrees centigrade to adversely thermally affect and modify an adherent material, this method is not appropriate as a method of producing a sealing film of an organic EL element that is particularly easily affected by heat and UV rays.

13) Driving Method

In the organic electroluminescence element of the present invention, when a DC (AC components may be contained as occasion arises) voltage (usually 2 volts to 15 volts) or DC is applied across the anode and the cathode, luminescence can be obtained.

For the driving method of the organic electroluminescence element of the present invention, the driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

### APPLICATION OF THE COLOR DISPLAY OF THE PRESENT INVENTION

The color display of the present invention can be appropriately used in wide fields including displays for mobile phone, personal digital assistants (PDAs), computer displays, car information displays, TV monitors, and general illuminations.

All publications, patent applications, and technical standards mentioned in this specification are herein incorporated by reference to the same extent as if each individual publication, patent application, or technical standard was specifically and individually indicated to be incorporated by reference.

### EXAMPLES

In the following, the invention will be explained by examples thereof, but the invention is by no means limited by such examples.

### Example 1

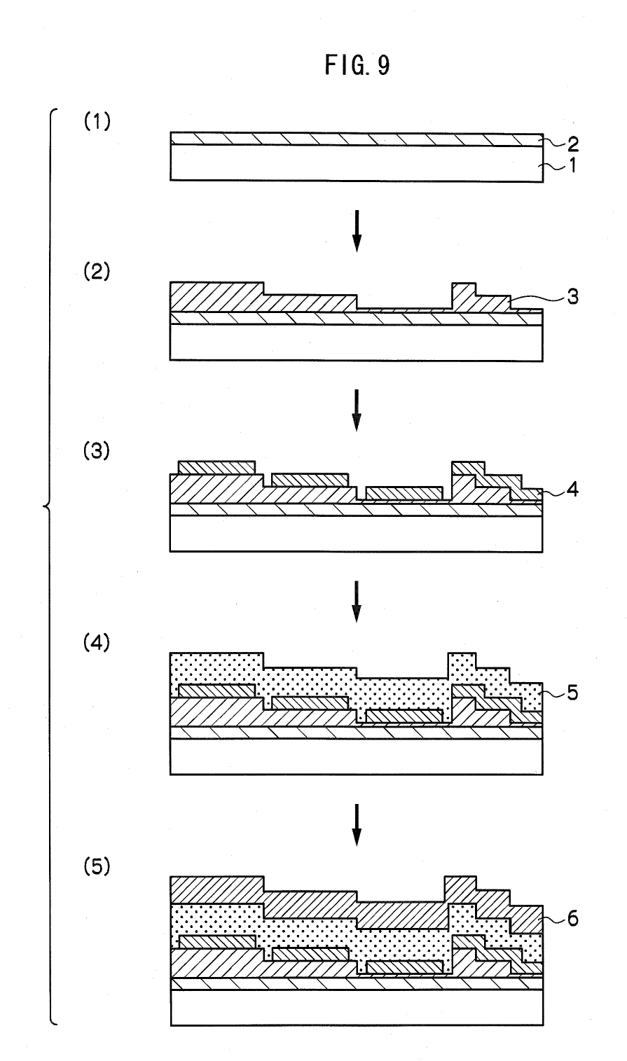

The production method of the invention will be described with reference to the drawings. FIG. 9 illustrates production processes in accordance with a process order. The structure obtained is illustrated in FIG. 6.
(1) Ag is vapor deposited to have a thickness of 20 nm on a glass substrate 1 to form a layer that partially transmits light and partially reflects light 2.
(2) A transparent electric insulating layer 3 (optical path length-adjusting layer) is formed on the upper surface of the layer that partially transmits light and partially reflects light 2, while varying the film thickness according to the position of each of R, G, and B sub-pixels as described below. Simultaneously, a transparent electric insulating layer 3 is formed while varying the film thickness, similarly as in each of the R, G, and B sub-pixels, according to the position of each of the R, G, and B sub-sub-pixels obtained by dividing an area at the position of a W sub-pixel into R, G, and B areas.

Material: SiON

Film forming method: ion plating method

Thickness: 230 nm of R portion, 170 nm of G portion, 120 nm of B portion
(3) A transparent electrode (ITO, 100 nm) is formed as a first electrode 4 by patterning to each sub-pixel on the upper surface of the optical path length-adjusting layer 3.

(4) An organic electroluminescence layer 5 that emits a white light is consistently formed on the upper surface of the transparent electrode 4, in common to the R, G, B, and W sub-pixels in the following order by a vacuum film forming method.

<Structure of Electroluminescence Layer>

Hole injection layer: 4,4′,4″-tris(2-naphthylphenylamino)triphenylamine (abbreviated as 2-TNATA) and F4-TCNQ (tetrafluorotetracyanoquinodimethane) are vapor codeposited so that F4-TCNQ is included in an amount of 1.0% by weight with respect to 2-TNATA. The film thickness is 50 nm.

Hole transport layer: N,N′-dinaphthyl-N,N′-diphenyl-[1,1′-biphenyl]-4,4′-diamine (abbreviated as α-NPD) is formed at a film thickness of 10 nm.

Light-emitting layer: four elements of 1,3-bis(carbazol-9-yl)benzene (abbreviated as mCP), a light-emitting material A, a light-emitting material B, and a light-emitting material C are vapor codeposited, so that the light-emitting material A is included in an amount of 15% by weight, the light-emitting material B is included in an amount of 0.13% by weight, and the light-emitting material C is included in an amount of 0.13% by weight with respect to mCP. The film thickness is 30 nm.

Electron transport layer: aluminium (III) bis-(2-methyl-8-quinolinato)-4-phenylphenolate (abbreviated as BAlq) is formed at a film thickness of 40 nm.

Electron injection layer: LiF (lithium fluoride) is formed at a film thickness of 0.5 nm.

The structures of the compounds used in examples are shown below.

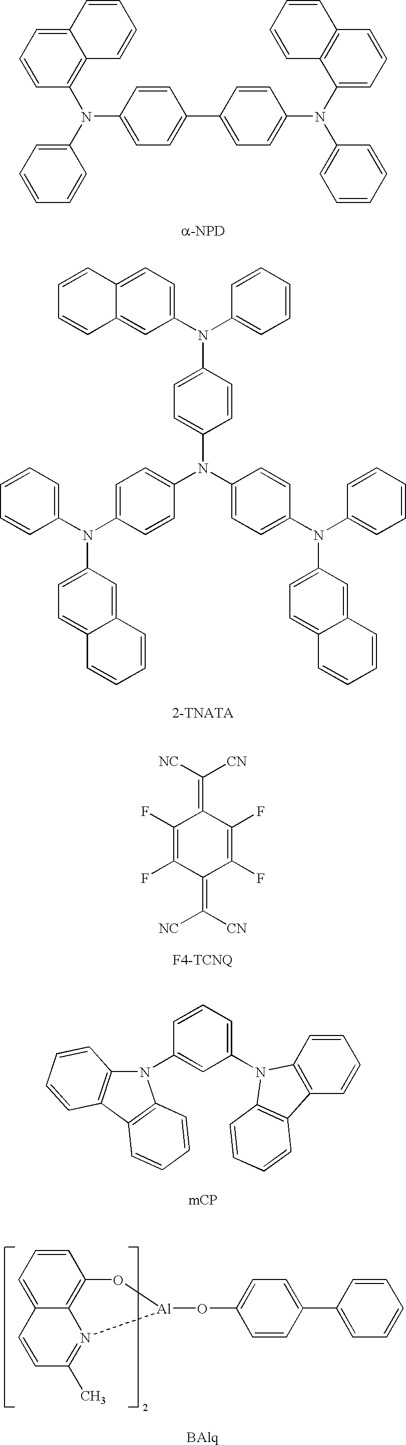

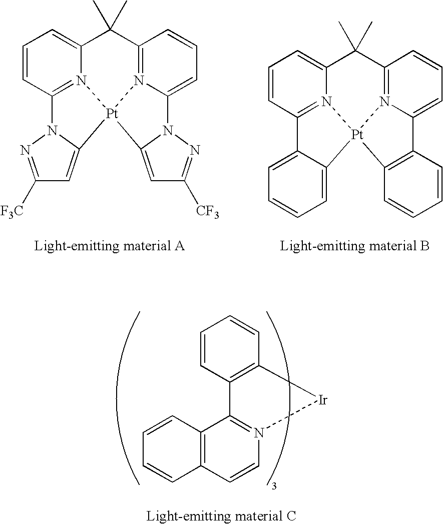

(5) A light reflection electrode (Al, 100 nm) is formed as a second electrode 6 by a vacuum film forming method.

The obtained organic electroluminescence layer formation area is sealed, and each electrode is connected to an external signal controller.

Thus, one pixel in which a bottom emission organic EL element is incorporated is formed.

A display surface is formed by arranging a plurality of pixels containing the R, G, B, and W sub-pixels. By selectively emitting light at each sub-pixel, an image is formed on the display surface. In such a case, the spectral properties of the light emitted from the W sub-pixel are different from those of the white organic electroluminescence layer itself, and spectral properties according to the R, G, and B optical resonators formed in the W sub-pixel by area division are obtained. In each colored light emitted from each of the R, G, and B optical resonators in the W sub-pixel, the brightness balance is designed depending on the area, and emission at W sub-pixel lighting is adjusted near a CIE color coordinate (0.31, 0.31).

The light emitted in the organic electroluminescence layer 5 by applying an electric current resonates between the layer that partially transmits light and partially reflects light 2 and the light reflection electrode 6, and the R, G, and B lights transmit through the substrate 1 to be emitted to the outside. In the W sub-pixel unit, the resonated R, G, and B lights are mixed to be observed as a white light.

According to the above-described production method, the R, G, B sub-pixels and the R, G, and B sub-sub-pixels are formed of the same material for each same color, except that the thickness of the optical path length-adjusting layer is different from each other. In particular, the organic electroluminescence layer is common and can be consistently formed, and thus the necessity of individually forming for each sub-pixel is eliminated, the production process thereof is simplified, the productivity increases, and high definition is easily achieved.

### Example 2

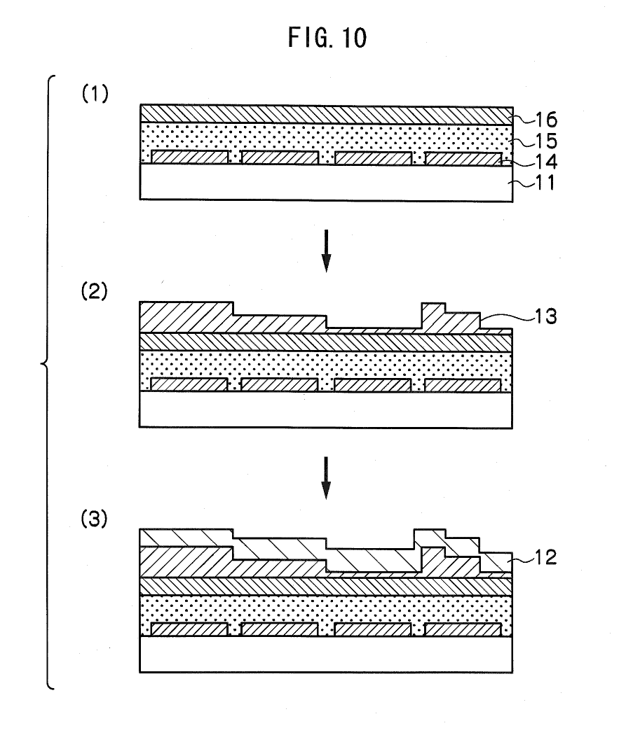

By reversing the lamination order of the transparent electrode/the white organic electroluminescence layer/the light reflection electrode in Example 1, a top emission structure in which light is emitted to the upper surface can be formed. FIG. 10 illustrates production processes in accordance with a process order. The structure obtained is illustrated in FIG. 7.

On a substrate 11, a light reflection electrode 14 patterned to R, G, B, and W sub-pixel areas/an organic electroluminescence layer 15/a transparent electrode 16 are prepared. Specifically, the light reflection electrode 14 is formed by a vacuum film forming method using Al in such a manner as to have a thickness of 100 nm. The organic electroluminescence layer 15 which emits a white light has a similar composition to that of the organic electroluminescence layer 5 which emits a white light of Example 1 and is obtained by reversing the lamination order. The transparent electrode 16 is formed by a vacuum deposition method using ITO in such a manner as to have a thickness of 100 nm.

Subsequently, in a similar manner to that described in Example 1(2) above, an electric insulating layer 13 is formed on the transparent electrode 16 as an optical path length-adjusting layer while varying the film thickness according to the position of each of the R G, B sub-pixels and each of the R, G, and B sub-sub-pixels so that a resonator is formed.

Material: SiON

Film forming method: ion plating method

Thickness: 230 nm of R portion, 170 nm of G portion, 120 nm of B portion

Subsequently, Ag is vapor deposited as a layer that partially transmits light and partially reflects light 12 in such a manner as to have a thickness of 20 nm.

The obtained organic electroluminescence layer formation area is sealed, and each electrode is connected to an external signal controller.

Thus, one pixel in which a top emission organic EL element is incorporated is formed.

A display surface is formed by arranging a plurality of pixels containing the R, G, B, and W sub-pixels. By selectively emitting light at each sub-pixel, an image is formed on the display surface. In such a case, the spectral properties of the light emitted from the W sub-pixel are different from those of the white organic electroluminescence layer itself, and spectral properties according to the R, G, and B optical resonators formed in the W sub-pixel by area division are obtained. In each colored light emitted from each of the R, G, and B optical resonators in the W sub-pixel, the brightness balance is designed depending on the area, and emission at W sub-pixel lighting is adjusted near a CIE color coordinate (0.31, 0.31).

The light emitted in the organic electroluminescence layer 15 by applying an electric current, resonates between the layer that partially transmits light and partially reflects light 12 and the light reflection electrode 14, and the R, G, and B lights transmit through the layer that partially transmits light and partially reflects light 12 to be emitted to the outside. In the W sub-pixel unit, the resonated R, G, and B lights are mixed to be observed as a white light.

### Example 3

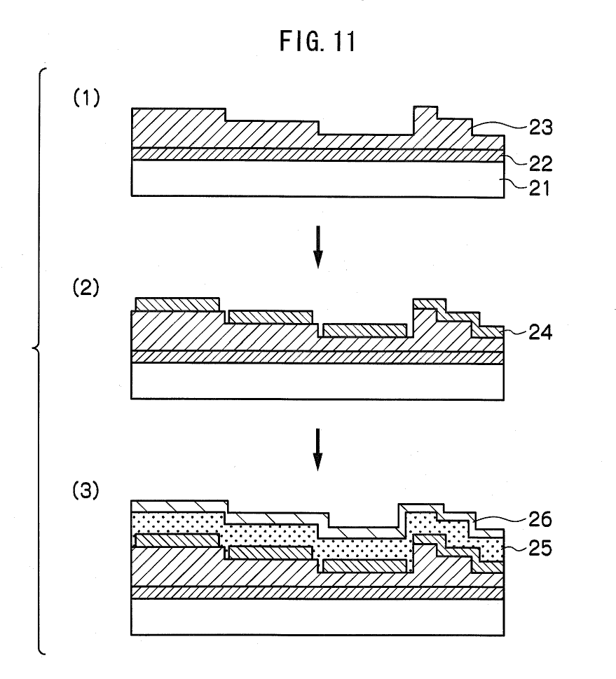

A modification example of a top emission structure of Example 2 is described. FIG. 11 illustrates production processes in accordance with a process order. The structure obtained is illustrated in FIG. 8.

On a substrate 21, a light reflection layer 22 is formed, and thereafter, in a similar manner to that described in Example 1(2) above, an electric insulating layer 23 is formed as an optical path length-adjusting layer while varying the film thickness according to the position of each of the R G, B sub-pixels and each of the R, G, and B sub-sub-pixels so that a resonator is formed.

Material: SiON

Film forming method: ion plating method

Thickness: 230 nm of R portion, 170 nm of G portion, 120 nm of B portion

On the electric insulating layer 23, a patterned transparent electrode 24 is prepared to be divided to each of the sub-pixels.

Subsequently, an organic electroluminescence layer 25 that emits a white light is consistently formed on the upper surface of the transparent electrode 24. The organic electroluminescence layer 25 has a similar composition to that of the organic electroluminescence layer 5 which emits a white light of Example 1, and is obtained by reversing the lamination order. In addition, an Al layer is added in a thickness of 1.5 nm on the electron injection layer LiF to form an electron injection layer in combination.

On the organic electroluminescence layer which emits a white light, an electrode that partially transmits light and partially reflects light 26 (Ag, 20 nm) is formed.

The obtained organic electroluminescence layer formation area is sealed, and each electrode is connected to an external signal controller.

Thus, one pixel in which a top emission organic EL element is incorporated is formed.

A display surface is formed by arranging a plurality of pixels containing the R, G, B, and W sub-pixels. By selectively emitting light at each sub-pixel, an image is formed on the display surface. In such a case, the spectral properties of the light emitted from the W sub-pixel are different from those of the white organic electroluminescence layer itself, and spectral properties according to the R, G, and B optical resonators formed in the W sub-pixel by area division are obtained. In each colored light emitted from each of the R, G, and B optical resonators in the W sub-pixel, the brightness balance is designed depending on the area, and emission at W sub-pixel lighting is adjusted near a CIE color coordinate (0.31, 0.31).

The light emitted in the organic electroluminescence layer 25 by applying an electric current, resonates between the electrode that partially transmits light and partially reflects light 26 and the light reflection layer 22, and the R, G, and B lights transmit through the electrode that partially transmits light and partially reflects light 26 to be emitted to the outside. In the W sub-pixel unit, the resonated R, G, and B lights are mixed to be observed as a white light.

According to the above-described production methods of Examples 1 to 3, a white light emitted from the W sub-pixel unit is formed of a mixture of the resonated R, G, and B lights, and hue variation arising depending on the direction in which the display surface is observed is prevented.

Moreover, as all the light components of the R, G, B, and W sub-pixels have a narrow wavelength distribution and an extremely high brightness, color purity of each light increases (a chromaticity band is broadened), and excellent color reproduction can be achieved.

According to the production method of the invention, the organic electroluminescence layer can be consistently formed with the same composition and, moreover, the optical resonator of the W sub-pixel is formed by the same process as that of the optical resonators of the R, G, and B sub-pixels, and thus, the production process is simple, and high definition is easily achieved.

Reference numerals used in Figures of the invention are explained below.
1, 11, 21: Substrate

2, 12, 26: Layer that partially transmits light and partially reflects light (Electrode that partially transmits light and partially reflects light)
3, 13, 23: Optical path length-adjusting layer (Electric insulating layer)
4, 16, 24: Transparent electrode
5, 15, 25: Organic electroluminescence layer
6, 14, 22: Light reflection layer (Light reflection electrode)

What is claimed is:

1. A color display comprising a plurality of pixels on a substrate, each pixels being area-divided into plural sub-pixels including at least two sub-pixels that each emit colored light of different wavelengths and a white sub-pixel, wherein the at least two sub-pixels and the white sub-pixel each have at least an optical path length-adjusting layer and an organic electroluminescence layer interposed between a layer that partially transmits light and partially reflects light and a light reflection layer to form a resonator structure.

2. The color display according to claim 1, wherein the white sub-pixel is area-divided into at least two sub-sub-pixels that each emit colored light of different wavelengths, and the at least two sub-sub-pixels each form a resonator structure.

3. The color display according to claim 1, wherein the at least two sub-pixels include at least three sub-pixels including a red sub-pixel, a green sub-pixel and a blue sub-pixel, and the white sub-pixel includes three sub-sub-pixels of a red sub-sub-pixel, a green sub-sub-pixel and a blue sub-sub-pixel.

4. The color display according to claim 3, wherein the resonator structures of the red sub-pixel, the green sub-pixel, and the blue sub-pixel and the resonator structures of the red sub-sub-pixel, the green sub-sub-pixel, and the blue sub-sub-pixel are respectively substantially the same for each same color.

5. The color display according to claim 1, wherein the organic electroluminescence layers of the at least two sub-pixels and the white sub-pixel are layers that each emit a white light, and comprise substantially the same composition as each other.

6. The color display according to claim 1, wherein the optical path length-adjusting layer is formed of an inorganic electric insulating material.

7. The color display according to claim 3, wherein the optical path length-adjusting layers of the red sub-pixel, the green sub-pixel, the blue sub-pixel, the red sub-sub-pixel, the green sub-sub-pixel, and the blue sub-sub-pixel comprise substantially the same material as each other and are different in thickness.

8. The color display according to claim 3, wherein the organic electroluminescence layers of the red sub-pixel, the green sub-pixel, the blue sub-pixel, the red sub-sub-pixel, the green sub-sub-pixel, and the blue sub-sub-pixel respectively comprise layers that emit a white light and have substantially the same composition as each other, and the optical path length-adjusting layers of the red sub-pixel, the green sub-pixel, the blue sub-pixel, the red sub-sub-pixel, the green sub-sub-pixel, and the blue sub-sub-pixel comprise substantially the same material as each other and are different in thickness.

9. A method for producing a color display in which a plurality of pixels is formed on a substrate, each pixel being area-divided into plural sub-pixels including at least two sub-pixels that each emit colored light of different wavelengths and a white sub-pixel, wherein the white sub-pixel is area-divided into at least two sub-sub-pixels that each emit colored light of different wavelengths, and the at least two sub-pixels and the at least two sub-sub-pixels each form a resonator structure, the resonator structure having at least an optical path length-adjusting layer and an organic electroluminescence layer interposed between a layer that partially transmits light and partially reflects light and a light reflection layer, in which the organic electroluminescence layer is a white light-emitting layer, the method comprising:
successively forming the organic electroluminescence layers of the at least two sub-pixels and the at least two sub-sub-pixels with substantially the same composition;
successively forming the optical path length-adjusting layers of the at least two sub-pixels and the at least two sub-sub-pixels with substantially the same material; and
adjusting a wavelength of light to be emitted by a thickness of the optical path length-adjusting layer.

10. The method for producing a color display according to claim 9, wherein the at least two sub-pixels include at least three sub-pixels including a red sub-pixel, a green sub-pixel and a blue sub-pixel, and the white sub-pixel includes three sub-sub-pixels of a red sub-sub-pixel, a green sub-sub-pixel and a blue sub-sub-pixel.

11. The method for producing a color display according to claim 10, wherein the thickness of each of the optical path length-adjusting layers of the red sub-pixel, the green sub-pixel, and the blue sub-pixel and the thickness of each of the optical path length-adjusting layers of the red sub-sub-pixel, the green sub-sub-pixel, and the blue sub-sub-pixel are substantially the same for each same color.

12. The method for producing a color display according to claim 9, wherein the optical path length-adjusting layer is formed of an inorganic electric insulating material.
